(19) United States
(12) Patent Application Publication
(10) Pub. No.: US 2006/0280503 A1
(43) Pub. Date: Dec. 14, 2006

(54) Remote controller for a big-horsepower wood-waste collecting machine

(75) Inventor: Chieh-Yuan Cheng, Taichung (TW)

Correspondence Address: TROXELL LAW OFFICE PLLC;SUITE 1404, 5205 LEESBURG PIKE, FALLS CHURCH, VA, 22041, US

(73) Assignee: San Ford Machinery Co., Ltd.

(21) Appl. No.: 11/150,131

(22) Filed: Jun. 13, 2005

(51) Int. Cl. H04B 10/00

(52) U.S. Cl. 398/106

(57) ABSTRACT

A remote controller for a big-horsepower wood-waste collecting machine includes an electromagnetic valve, an IC panel and an infrared remote controller. The electromagnetic valve is set between a main power source and a machine motor for properly controlling to pass or cut off the power. The IC panel is properly linked with the electromagnetic valve and has an infrared receiving circuit for receiving a remote signal. The infrared remote controller, separated from the machine, has an infrared transmitting circuit to transmit a remote signal. The IC panel can receive the remote signal to command the electromagnetic valve to pass or cut off the power.

### BACKGROUND OF THE INVENTION

1. Field of the Invention

This invention relates to a wood-waste colleting machine, especially one equipped with a remote-controller for turning on and off the machine.

2. Description of the Prior Art

The machine body of a big-horsepower wood-waste collecting machine, usually having a great mass and a heavy weight, is uneasy to move around from the sucking location to the working position and vice versa. As the machine is always set fixedly and extends its tube to approach the working position or where needs sucking wood waste.

Since the machine is set fixedly, whenever it is to be started or stopped, a user has to move in person to do the operation. Unfortunately, the working table and the machine are always situated apart in quite a distance, not only very inconvenient but also wasting time, causing a low efficiency.

### SUMMARY OF THE INVENTION

The prime object of this invention is to offer a remote-controller for a big-horsepower wood-waste collecting machine.

The invention includes an electromagnetic valve, an IC panel and an infrared remote controller. The electromagnetic valve is set between a main power source and a motor for properly controlling to pass or cut off the power supplied for the motor. The IC panel is properly linked with the electromagnetic valve and has an infrared receiving circuit for receiving a remote signal. The infrared remote controller, separated from the machine, has an infrared radiating circuit to transmit a remote signal. The IC panel can receive the remote signal to command the electromagnetic valve to pass or cut off the power for the motor.

### BRIEF DESCRIPTION OF DRAWINGS

FIG. 1 is a block diagram of a remote controller in the present invention;

FIG. 2 is a diagram of the connecting line between an electromagnetic valve and an IC panel in the present invention;

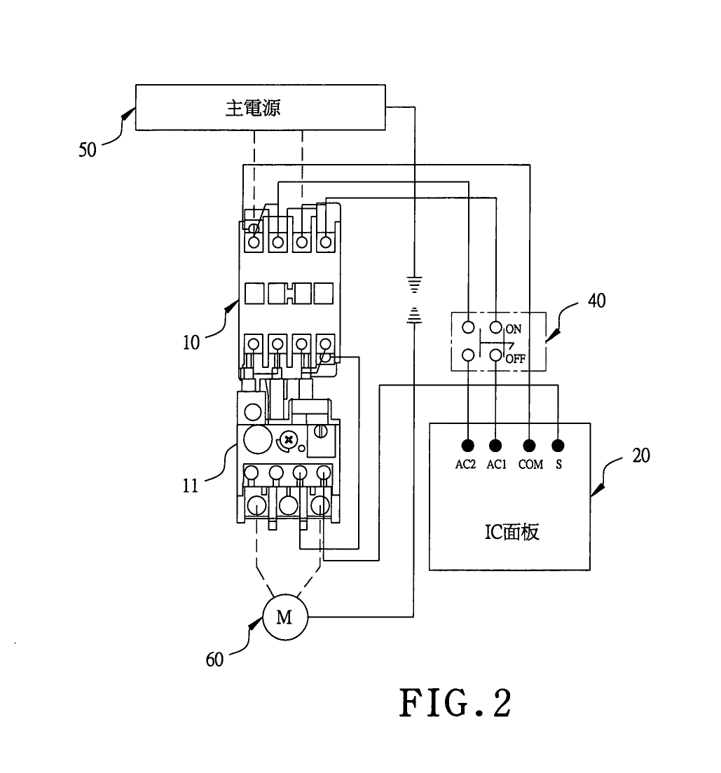

FIG. 3 is a diagram of the interior circuit of the IC panel in the present invention;

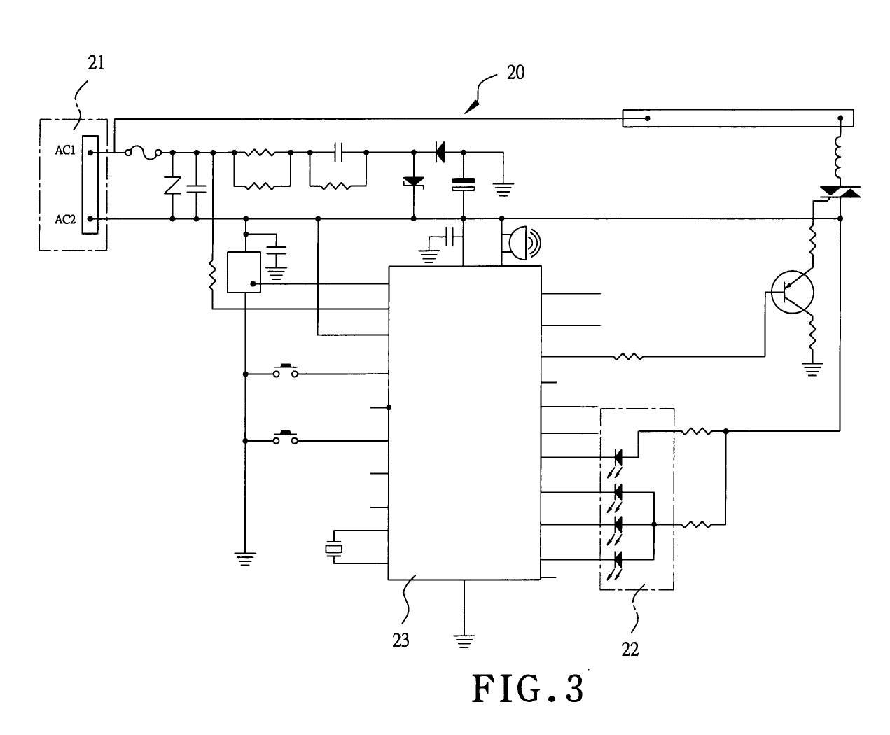

FIG. 4 is a diagram of the interior circuit of the infrared remote controller in the present invention.

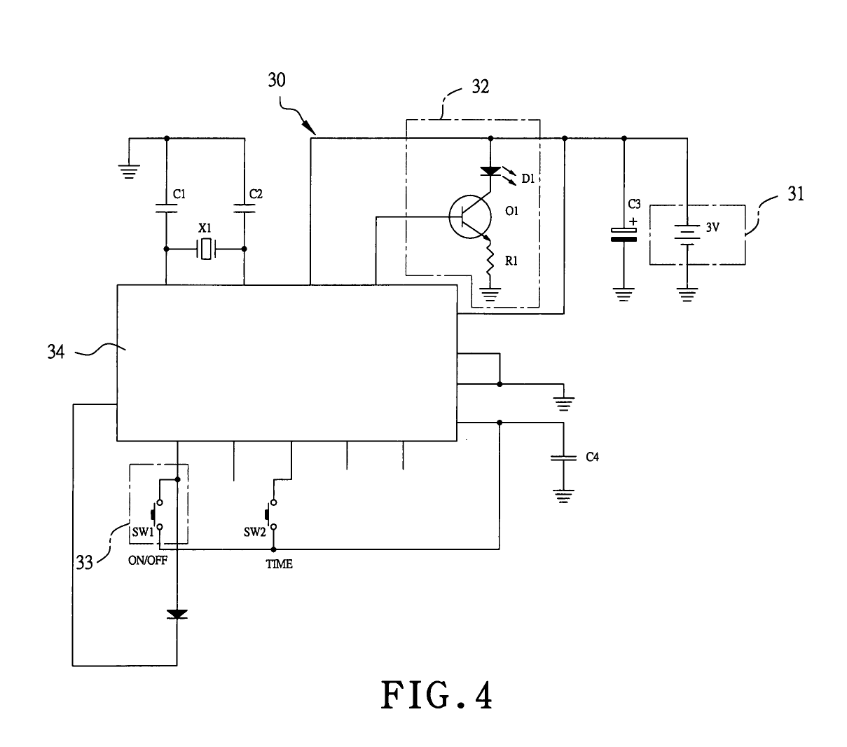

### DETAILED DESCRIPTION OF THE PREFERRED EMBODIMENT

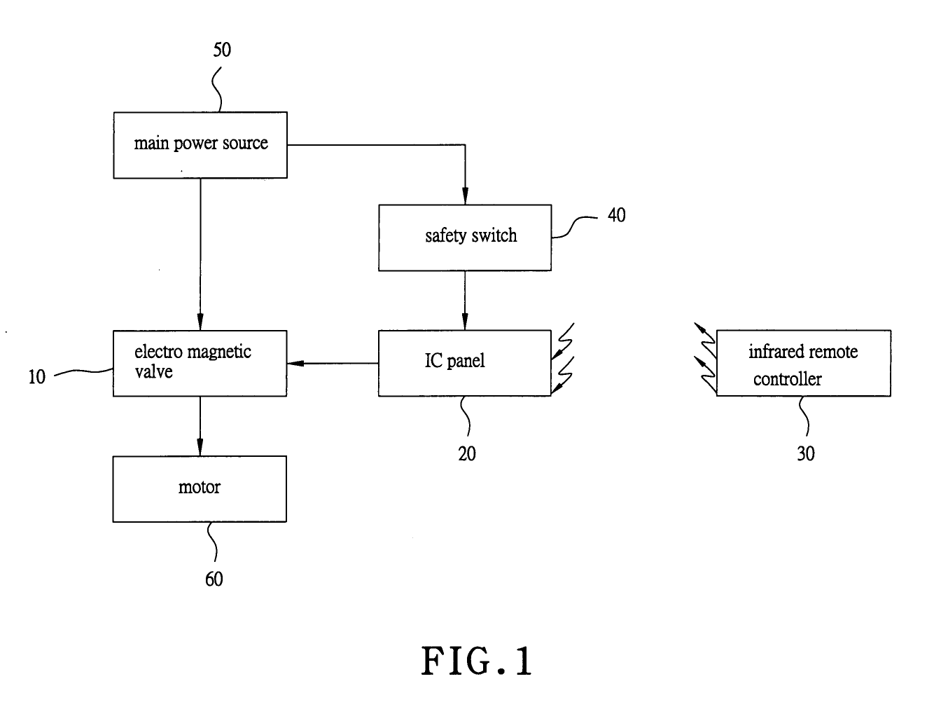

A preferred embodiment of a remote-controller for a big-horsepower wood-waste collecting machine in the present invention, as shown in FIG. 1, includes an electromagnetic valve 10, an IC panel 20, an infrared remote controller 30 and a safety switch 40 as main components.

The electromagnetic valve 10 is set between a main power source 50 and a motor 60 for properly controlling to pass or cut off the power supplied by the main power source 50 for the motor 60, and has an overload relay 11 linked in series so as to cut off the power automatically in case of overloading, preventing both the motor 60 and related circuits from being damaged.

The IC panel 20 is properly linked with the electromagnetic valve 10 and has a power input terminal 21 to connect with the main power source 50 and an infrared receiving circuit for receiving a remote signal and decoding properly to transfer it to a CPU 23 for data processing and then passing a current control signal to the electromagnetic valve 10 to pass or cut off the power for starting or stopping the motor 60.

The infrared remote controller 30, separated from the wood-waste collecting machine, consists of a battery 31, an infrared transmitting circuit 32, a changeover switch 33 and a CPU 34. The battery 32 provides power for the interior circuit and other electronic components. The changeover switch 33 is pressed manually to send a control signal to the CPU 34 for data processing and, then, to command the infrared transmitting circuit 32 to transmit an infrared signal to the infrared receiving circuit 22 in the IC panel 20.

The safety switch 40 is connected between the IC panel 20 and the main power source 50 and pressed manually to cut off the voltage of the IC panel 20 supplied by the main power source 50 for preventing the IC panel 20 from receiving the remote signal.

Referring to FIG. 1 again, the remote-control device in this present invention is mainly applied to a big-horsepower wood-waste collecting machine. While the machine stays out working hours, the safety switch 40, in order to keep the infrared remote controller 30 from being touched unintentionally to start the machine to work, can be turned OFF to keep the IC panel 20 from powered by the main power source 50. Therefore, the IC panel 20 is kept dead to any remote signal and the electromagnetic valve 10 naturally is not activated. With the safety device, the machine is impossible to be started unintentionally to cause any accident or damage.

On the contrary, the safety switch 40 can be turn on during the working hours. If the machine needs to be operated, keep the infrared remote controller 30 aiming at the IC panel 20, and then press the changeover switch 33 on the infrared remote controller 30 to enable the infrared transmitting circuit 32 to send out a remote signal, which is to be received by the infrared receiving circuit 22. Then, the data is processed by the CPU 23, which will send a controlled signal to command the electromagnetic valve 10 to pass the power to start the motor 60. If the motor 60 is to be stopped, just repeat the above steps as described previously. Accordingly, the user doesn't have to move to and fro, as the conventional one needs, to turn on and off the machine, but just uses the infrared remote controller 30 instead to control the on/off of the machine without moving around. It is not only more convenient, but also time-saving and more efficient.

Furthermore, the remote-control device in the present invention uses the IC panel 20 to control the electromagnetic valve 10, which is then to control the motor 60. As the control is not done by the IC panel 20 directly, and the electromagnetic valve 10 can usually endure larger current flow, more suitable for a wood-waste collecting machine requiring a big horsepower and high current flow, without possibility to burn out the IC panel 20. And, due to using infrared for controlling, the infrared remote controller 30 can send effective signal only when it is aiming straight at the IC panel 20 without any obstacle and pressed so that the motor 60 can be started or stopped. Therefore, it will lessen a lot of probability for starting or stopping the vacuum motor 60 unintentionally carelessly pressing on the infrared remote controller 30.

While the preferred embodiment of the invention has been described above, it will be recognized and understood that various modifications may be made therein and the appended claims are intended to cover all such modifications that may fall within the spirit and scope of the invention.

What is claimed is:

1. A remote-controller for a big-horsepower wood-waste collecting machine and said remote controller comprising:
An electromagnetic valve set between a main power source and a motor for properly controlling to pass or cut off the power supplied for a machine motor;
an IC panel properly linked with said electromagnetic valve and having a power input terminal to connect with said main power source and an infrared receiving circuit for receiving a remote signal and decoding properly to transmit it to a CPU for data processing, said CPU passing a control signal to said electromagnetic valve to pass or cut off the power for starting or stopping said motor; and
an infrared remote controller, separated from said machine and possessing an infrared transmitting circuit able to transmit an infrared signal to be received by said infrared receiving circuit in said IC panel.

2. The remote-control device for a big-horsepower wood-waste collecting machine as claimed in claim 1, wherein a safety switch is set between said IC panel and said main power source and able to cut off working voltage for said IC panel.

3. The remote-control device for a big-horsepower wood-waste collecting machine as claimed in claim 1, wherein said electromagnetic valve has an overload relay set in series.

4. The remote-control device for a big-horsepower wood-waste collecting machine as claimed in claim 1, wherein said infrared remote controller comprises a battery, a CPU and a changeover switch which, if pressed manually, can drive said CPU and said infrared transmitting circuit to send out a remote signal.
